(19) United States
(12) Patent Application Publication
(10) Pub. No.: US 2025/0225800 A1
(43) Pub. Date: Jul. 10, 2025

(54) METHOD, APPARATUS, SYSTEM, AND NON-TRANSITORY COMPUTER READABLE MEDIUM FOR EXPERIENTIAL BASED INVESTMENT RECOMMENDATIONS

(71) Applicant: Charles Schwab & Co., Inc., San Francisco, CA (US)

(72) Inventors: Roman Paolo PASCUA, Austin, TX (US); Naurin NASIM, Pflugerville, TX (US); Jeffrey Michael FREISTHLER, Ann Arbor, MI (US)

(73) Assignee: Charles Schwab & Co., Inc., San Francisco, CA (US)

(21) Appl. No.: 18/961,761

(22) Filed: Nov. 27, 2024

Related U.S. Application Data
(60) Provisional application No. 63/619,494, filed on Jan. 10, 2024.

(51) Int. Cl. G06V 20/70; G06F 40/279; G06Q 40/06; G06V 10/764

(52) U.S. Cl. CPC G06V 20/70; G06F 40/279; G06Q 40/06; G06V 10/764

(57) ABSTRACT

A system, apparatus, method, and non-transitory computer readable medium for providing theme based investment recommendations may include a computing device caused to, obtain at least one image associated with at least one user, recognize at least one object included in the at least one image using image analysis, determine at least one theme from a plurality of themes based on the recognized at least one object, and provide at least one recommendation to the at least one user based on the at least one theme.

### CROSS-REFERENCE TO RELATED APPLICATIONS

This application claims priority to U.S. Provisional Patent Application No. 63/619,494, filed on Jan. 10, 2024, the entire disclosure of which is incorporated by reference.

### BACKGROUND

### Field

Various example embodiments relate to methods, apparatuses, systems, and/or non-transitory computer readable media for providing theme-based investment recommendations.

### Description of the Related Art

Investors may perform research regarding investment opportunities and/or receive trading recommendations from financial advisors, brokerage firms, news media, social media, and the like, before using brokerage firms and/or security exchanges to execute security trading transactions, such as buying or selling stocks, bonds, commodities, options, futures, etc. However, traditional forms of investment research rely on the investor to have some a priori knowledge of the companies, products, and/or financial sectors in order to begin their research, or required the investor to passively receive information or recommendations investment opportunities from news media, social media, etc., regardless of the relevance of the potential investment opportunities to the investor. Consequently, it is difficult and time consuming for people who are not investment professionals, such as retail investors, retirees, etc., to identify potential investment opportunities and/or perform research on potential investment opportunities.

### SUMMARY

At least one example embodiment is related to a computing device.

In at least one example embodiment, the computing device may include a memory storing computer readable instructions, and processing circuitry configured to execute the computer readable instructions to cause the computing device to, obtain at least one image associated with at least one user, recognize at least one object included in the at least one image using image analysis, determine at least one theme from a plurality of themes based on the recognized at least one object, and provide at least one recommendation to the at least one user based on the at least one theme.

Some example embodiments provide that the processing circuitry is further configured to execute the computer readable instructions to cause the computing device to, obtain a plurality of images from a source of images associated with the at least one user, the plurality of images including the at least one image, and receive at least one user input from the user, the at least one user input selecting the at least one image from the plurality of images.

Some example embodiments provide that the processing circuitry is further configured to execute the computer readable instructions to cause the computing device to recognize the at least one object included in the at least one image by, for each image of the at least one image, identifying each object included in the respective image, the identifying including calculating a confidence value associated with each identified object, and for each identified object, determining an object name corresponding to the respective identified object in response to the confidence value associated with the respective identified object satisfying a desired threshold confidence value, and associating the respective identified object with the respective image as the recognized at least one object associated with the respective image.

Some example embodiments provide that the plurality of themes are each associated with a set of keywords, and the processing circuitry is further configured to execute the computer readable instructions to cause the computing device to determine the at least one theme based on the recognized at least one object by, determining a relevance score using a natural language processing model between each recognized object associated with the at least one image and each theme of the plurality of themes based on the determined object name of the respective recognized object and the keywords associated with the respective theme, and determining the at least one theme associated with the at least one image based on the determined relevance scores.

Some example embodiments provide that the processing circuitry is further configured to execute the computer readable instructions to cause the computing device to determine the at least one theme associated with the at least one image based on the determined relevance scores by, determining a word similarity score between the determined object name of each recognized object and each of the keywords associated with the respective theme, determining a relevancy score based on the determined word similarity scores between the determined object name and the respective theme, and associating the respective theme to the respective image corresponding to the respective object based on the determined relevancy score and a desired theme threshold value.

Some example embodiments provide that the at least one theme associated with the at least one image is a plurality of themes associated with the at least one image, and the processing circuitry is further configured to execute the computer readable instructions to cause the computing device to determine at least one recommendation associated with each of the plurality of themes associated with the at least one image.

Some example embodiments provide that the at least one image associated with the user is a plurality of images associated with the user, each of the plurality of images associated with a plurality of themes, and the processing circuitry is further configured to execute the computer readable instructions to cause the computing device to, calculate a weighted score for each of the plurality of themes, and provide the at least one recommendation to the at least one user based on the weighted score of each of the plurality of themes.

Some example embodiments provide that the processing circuitry is further configured to execute the computer readable instructions to cause the computing device to calculate the weighted score for each of the plurality of themes by, applying a weight to a maximum relevance score for each of the plurality of themes based on at least one of, a number of occurrences of the respective theme among the plurality of images, a number of recognized objects mapping to the respective theme among the plurality of images, a number of distinct images mapping to the respective theme, timestamp information associated with the distinct images mapping to the respective theme, geolocation information associated with the distinct images mapping to the respective theme, or any combinations thereof.

Some example embodiments provide that the processing circuitry is further configured to execute the computer readable instructions to cause the computing device to, display the at least one recommendation associated with each of the plurality of themes based on a ranking of the weighted relevance score of each of the plurality of themes.

Some example embodiments provide that the processing circuitry is further configured to execute the computer readable instructions to cause the computing device to, obtain at least one second image associated with at least one second user, recognize at least one second object included in the at least second one image using image analysis, determine the at least one theme from the plurality of themes based on the recognized at least one object and the recognized at least one second object, and provide the at least one recommendation to the at least one user and the at least one second user based on the at least one theme.

Some example embodiments provide that the processing circuitry is further configured to execute the computer readable instructions to cause the computing device to, receive a user input indicating creation of a new theme from the user, provide a plurality of themes to the user, receive a selection of at least two themes of the plurality of themes in response to the providing of the plurality of themes, and generate a new theme based on the selection of the at least two themes.

At least one example embodiment is related to a method of operating a computing device.

In at least one example embodiment, the method may include obtaining at least one image associated with at least one user, recognizing at least one object included in the at least one image using image analysis, determining at least one theme from a plurality of themes based on the recognized at least one object, and providing at least one recommendation to the at least one user based on the at least one theme.

Some example embodiments provide that the method may further include, receiving account credential information from the at least one user, obtaining a plurality of images associated with at least one account of the at least one user from a server based on the account credential information, the plurality of images including the at least one image, and receiving at least one user input from the user, the at least one user input selecting the at least one image from the plurality of images.

Some example embodiments provide that the recognizing the at least one object included in the at least one image further includes, for each image of the at least one image, identifying each object included in the respective image, the identifying including calculating a confidence value associated with each identified object, and for each identified object, determining an object name corresponding to the respective identified object in response to the confidence value associated with the respective identified object satisfying a desired threshold confidence value, and associating the respective identified object with the respective image as the recognized at least one object associated with the respective image.

Some example embodiments provide that the plurality of themes are each associated with a set of keywords, and the determining the at least one theme based on the recognized at least one object further includes, determining a relevance score using a natural language processing model between each recognized object associated with the at least one image and each theme of the plurality of themes based on the determined object name of the respective recognized object and the keywords associated with the respective theme, and determining the at least one theme associated with the at least one image based on the determined relevance scores.

Some example embodiments provide that the determining the relevance score using the natural language processing model further includes, determining a word similarity score between the determined object name of each recognized object recognized object and each of the keywords associated with the respective theme, determining a relevance score of the determined word similarity scores between the determined object name and the respective theme, and associating the respective theme to the respective image corresponding to the respective object based on the determined relevance score and a desired theme threshold value.

Some example embodiments provide that the at least one theme associated with the at least one image is a plurality of themes associated with the at least one image, and the method may further include determining at least one recommendation associated with each of the plurality of themes associated with the at least one image.

Some example embodiments provide that the at least one image associated with the user is a plurality of images associated with the user, each of the plurality of images associated with a plurality of themes, and the method may further include calculating a weighted relevance score for each of the plurality of themes, and providing the at least one recommendation to the at least one user based on the weighted relevance score of each of the plurality of themes.

Some example embodiments provide that the calculating the weighted relevance score for each of the plurality of themes further includes, applying a weight to a maximum relevance score for each of the plurality of themes based on at least one of, a number of occurrences of the respective theme among the plurality of images, a number of recognized objects mapping to the respective theme among the plurality of images, a number of distinct images mapping to the respective theme, timestamp information associated with the distinct images mapping to the respective theme, geolocation information associated with the distinct images mapping to the respective theme, or any combinations thereof.

Some example embodiments provide that the method may further include, displaying the at least one recommendation associated with each of the plurality of themes based on a ranking of the weighted relevance score of each of the plurality of themes.

Some example embodiments provide that the method may further include, obtaining at least one second image associated with at least one second user, recognizing at least one second object included in the at least second one image using image analysis, determining the at least one theme from the plurality of themes based on the recognized at least one object and the recognized at least one second object, and providing the at least one recommendation to the at least one user and the at least one second user based on the at least one theme.

Some example embodiments provide that the method may further include, receiving a user input indicating creation of a new theme from the user, providing a plurality of themes to the user, receiving a selection of at least two themes of the plurality of themes in response to the providing of the plurality of themes, and generating a new theme based on the selection of the at least two themes.

### BRIEF DESCRIPTION OF THE DRAWINGS

The accompanying drawings, which are incorporated in and constitute a part of the specification, illustrate one or more example embodiments and, together with the description, explain these example embodiments. In the drawings:

FIG. 1 illustrates a system associated with an online investment platform according to at least one example embodiment;

FIG. 2 illustrates a block diagram of an example client computing device according to at least one example embodiment;

FIG. 3 illustrates a block diagram of an example server computing device of the online investment platform according to at least one example embodiment;

FIG. 4 illustrates a transmission flow diagram according to at least one example embodiment;

FIGS. 5A to 5B illustrate image analysis performed on a first example image according to some example embodiments;

FIGS. 6A to 6B illustrate image analysis performed on a second example images according to some example embodiments;

FIG. 7 illustrates example theme-based investment recommendation graphical user interfaces (GUIs) according to at least one example embodiment;

FIG. 8 illustrates example theme-based investment research and trading GUIs according to at least one example embodiment; and

FIG. 9 illustrates example theme creation and sharing GUIs according to at least one example embodiment.

### DETAILED DESCRIPTION

Various example embodiments will now be described more fully with reference to the accompanying drawings in which some example embodiments are shown.

Detailed example embodiments are disclosed herein. However, specific structural and functional details disclosed herein are merely representative for purposes of describing the example embodiments. The example embodiments may, however, may be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the example embodiments. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of the example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of the example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware circuitry and/or software, firmware, middleware, microcode, hardware description languages, etc., in combination with hardware (e.g., software executed by hardware, etc.). When implemented in software, firmware, middleware or microcode, the program code or code segments to perform the desired tasks may be stored in a machine or computer readable medium such as a non-transitory computer storage medium, and loaded onto one or more processors to perform the desired tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the term “circuitry” and/or “hardware circuitry” may refer to one or more or all of the following: (a) hardware-only circuit implementation (such as implementations in only analog and/or digital circuitry); (b) combinations of hardware circuits and software, such as (as applicable): (i) a combination of analog and/or digital hardware circuit(s) with software/firmware, and (ii) any portions of hardware processor(s) with software (including digital signal processor(s)), software, and memory(ies) that work together to cause an apparatus, such as a mobile phone, a smart device, and/or server, etc., to perform various functions); and (c) hardware circuit(s) and/or processor(s), such as microprocessor(s) or a portion of a microprocessor(s), that requires software (e.g., firmware) for operation, but the software may not be present when it is not needed for operation. For example, the circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In an effort to improve the process of identifying potential investment recommendations and/or to conducting research on potential investment recommendations, there is a desire for systems, apparatuses, methods, and/or non-transitory computer readable media which will provide investors theme-based investment recommendations and/or research information based on everyday experiences of the investors. For example, such investment recommendations may be generated based on analysis of images, videos, audio, etc., captured by an investor related to their interests, uploaded on social media by the investor and/or family or friends of the investors, etc.

Accordingly, the investors may receive theme-based investment recommendations and/or research information which are tailored to their experiences and interests, of which they may have more intimate/expert knowledge, with less time investment and/or effort required on the investor's part. Due to the theme-based investment recommendations and/or research information being generated based on the investor's personal experience and/or interests, the investment recommendations and/or research information may be more relevant to the investor than reading investment news articles or watching investment-related social media videos or television programs, and may be less expensive and/or less time consuming than finding and meeting with a financial advisor, etc.

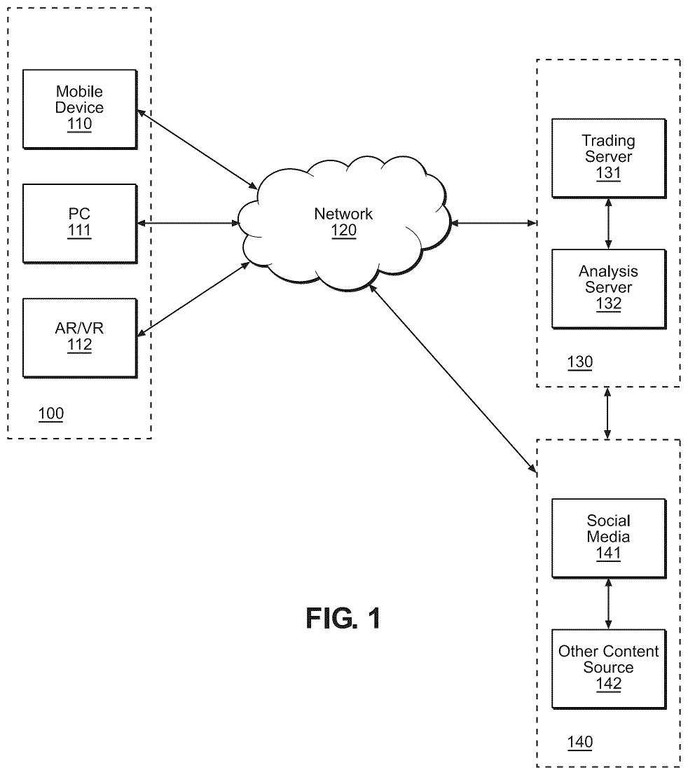

FIG. 1 illustrates a system associated with an online investment platform according to at least one example embodiment. As shown in FIG. 1, the online investment platform system includes a plurality of client devices 100 (e.g., user devices, etc.) including a mobile device 110, a personal computer 111, and an augmented reality (AR) and/or a virtual reality (VR) device 112, etc., a network 120, and at least one server 130 associated with the online investment platform, but the example embodiments are not limited thereto, and the example embodiments may include a greater or lesser number of constituent elements. According to at least one example embodiment, the server 130 may host and/or provide functionality of at least a portion of a desired brokerage firm and/or security exchange, etc., and may include a trading server 131 for receiving security transaction requests (e.g., buy orders, sell orders, etc.) from at least one user of the online investment platform and/or for providing investment research information related to one or more securities to the at least one user, and an analysis server 132 for performing analysis on user content, such as images, videos, audio, text, etc., uploaded to the online investment platform via the plurality of client devices 100 in order to generate a list of investment related themes which may be of interest to the user based on the results of the user content. Each of the themes included in the list of investment related themes are associated with one or more potential investment opportunities (e.g., themed baskets of stocks, bonds, real estate, etc.) relevant to the theme. Further, each of the one or more themes may also be associated with research information related to the potential investment opportunities, such as regulatory filings, financial data, financial news articles associated with the potential investment opportunity, etc., thereby simplifying and/or speeding up the research process for the user. Moreover, the user may directly conduct trade transactions for one or more of the potential investment opportunities through the client device 100. According to some example embodiments, the trading server 131 and the analysis server 132 may be implemented in a single server, or one or more of the trading server 131 and/or the analysis server 132 may be implemented as a plurality of servers, etc. Further, according to at least one example embodiment, the functionality of the analysis server 132 may be performed by the client device 100.

Further, according to some example embodiments, the system may further include external sources of user content 140, such as a social media account 141 associated with the user and/or identified by the user, or other content sources 142, such as an email account associated with the user, a storage device associated with the user, an online (e.g., cloud) storage service account associated with the user, a website of interest to the user, a forum of interest to the user, etc. The external sources of user content 140 may be accessed by the at least one server 130 based on user credential information (e.g., user account information, user passwords, etc.) supplied by the user, but the example embodiments are not limited thereto.

Additionally, each of the plurality of client devices 100 may allow a respective user to access the online investment platform via the at least one server 130. For example, one or more of the plurality of client devices 100 may have software application(s) (e.g., apps, programs, code, computer readable instructions, etc.) installed and/or may execute software application(s) corresponding to the online investment platform (e.g., the online investment platform client application, etc.), and/or one or more of the plurality of client devices 100 may have installed and/or may execute a web browser application which allows a corresponding user of the client device to access a website for the online investment platform, execute trades on the online investment platform, etc., but the example embodiments are not limited thereto.

According to some example embodiments, the client devices 100 may include computing devices, such as a personal computer (PC), a laptop, a server, a database system, a smartphone, a tablet, any other smart devices, a wearable device, an Internet-of-Things (IoT) device, an AR and/or VR device (hereinafter referred to as an AR device for simplicity), a virtual assistant device, a Personal Digital Assistant (PDA), etc., but are not limited thereto. Further, the system may include a plurality of additional servers associated with (and/or hosting, implementing, storing transaction data/research information, etc.) the online investment platform and/or additional servers corresponding to other brokerage firms and/or security exchanges, etc. Additionally, the system may include less than three client devices and/or the system may include greater than three client devices, etc.

The plurality of client devices 100 and the server 130 may be connected over the network 120, and the network 120 may correspond to a wireless network, such as a cellular wireless access network (e.g., a 3G wireless access network, a 4G-Long Term Evolution (LTE) network, a 5G-New Radio (e.g., 5G) wireless network, a WiFi network, a satellite network, etc.) and/or a wired network (e.g., a fiber network, a cable network, a PTSN, etc.). The server 130 may connect to other servers (not shown), over a wired and/or wireless network, and each of the client devices 110, 111, and/or 112 may connect to other client devices over a wired and/or wireless network. The network 120 may refer to the Internet, an intranet, a wide area network, etc.

While certain components of a system associated with an online investment platform are shown in FIG. 1, the example embodiments are not limited thereto, and the system may include components other than that shown in FIG. 1, which are desired, necessary, and/or beneficial for operation of the underlying networks within the system, such as servers, access points, switches, gateways, etc.

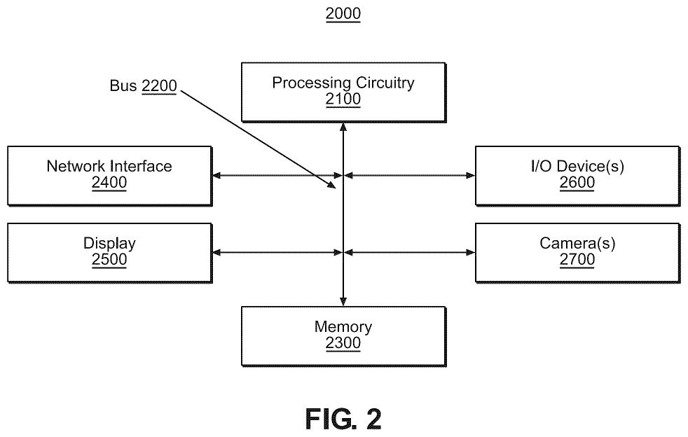

FIG. 2 illustrates a block diagram of an example client computing device of the online investment platform according to at least one example embodiment. The computing device 2000 of FIG. 2 may correspond to one or more of the plurality of client devices 100 of FIG. 1, but the example embodiments are not limited thereto.

Referring to FIG. 2, a computing device 2000 (e.g., a client device, a user device, etc.) may include processing circuitry 2100, at least one communication bus 2200, a memory 2300, at least one network interface 2400, and/or at least one input/output (I/O) device 2600 (e.g., a keyboard, a touchscreen, a mouse, a microphone, a speaker, etc.), etc., but the example embodiments are not limited thereto. For example, the computing device 2000 may further include a display panel 2500, such as a monitor, a touchscreen, a projector, etc., and/or a camera 2700, and the like. The memory 2300 may include various special purpose program code including computer executable instructions which may cause the computing device 2000 to perform one or more of the methods of the example embodiments.

In at least one example embodiment, the processing circuitry 2100 may include at least one processor (and/or processor cores, distributed processors, networked processors, etc.), which may be configured to control one or more elements of the computing device 2000, and thereby cause the computing device 2000 to perform various special purpose operations. The processing circuitry 2100 is configured to execute processes by retrieving program code (e.g., computer readable instructions) and data from the memory 2300 to process them, thereby executing special purpose control and functions of the entire computing device 2000. Once the special purpose program instructions are loaded into the processing circuitry 2100, the processing circuitry 2100 executes the special purpose program instructions, thereby transforming the processing circuitry 2100 into special purpose processing circuitry (e.g., a special purpose processor, etc.).

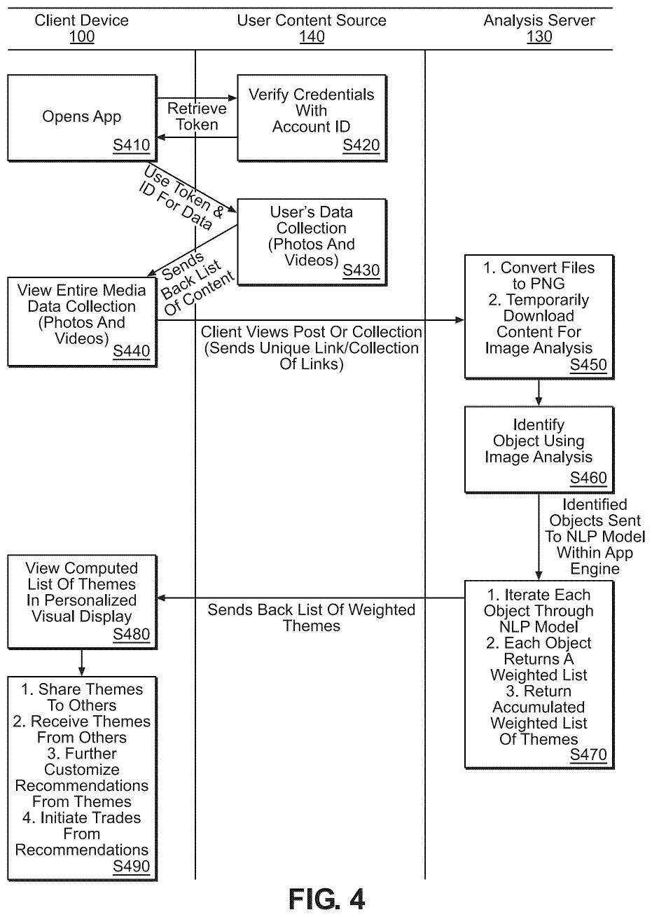

In at least one example embodiment, the memory 2300 may be a non-transitory computer-readable storage medium and may include a random access memory (RAM), a read only memory (ROM), and/or a permanent mass storage device such as a disk drive, or a solid state drive. Stored in the memory 2300 is program code (i.e., computer readable instructions) related to operating the computing device 2000, such as the methods discussed in connection with FIGS. 4 to 9, the at least one network interface 2400, and/or at least one I/O device 2600, etc. Such software elements may be loaded from a non-transitory computer-readable storage medium independent of the memory 2300, using a drive mechanism (not shown) connected to the computing device 2000, or via the at least one network interface 2400, and/or at least one I/O device 2600, etc.

In at least one example embodiment, the at least one communication bus 2200 may enable communication and/or data transmission to be performed between elements of the computing device 2000. The bus 2200 may be implemented using a high-speed serial bus, a parallel bus, and/or any other appropriate communication technology. According to some example embodiments, the computing device 2000 may include a plurality of communication buses (not shown).

The computing device 2000 may be associated with a user of an online investment platform and may be used to communicate with, for example, a trading server, a brokerage server, a financial services server (e.g., banking services, loan services, etc.), an analysis server, a web server, a messaging server, a search engine server, a news server, a gaming server, etc., or any combinations thereof. The computing device 2000 may be configured to access the online investment platform to receive investment recommendations, perform research on potential investments, perform security trading operations, associated with at least one user (e.g., a user account associated with the user) of the online investment platform. Further, the computing device 2000 may be configured to capture user content associated with the user, such as images, videos, audio, etc., via the I/O device 2600 and/or camera 2700 and transmit the captured user content to, for example, the server 130 and/or the external sources of user content 140, etc. The provided user content may be analyzed by the analysis server 132 to generate theme-based investment recommendations, provide research information regarding the investment recommendations, provide security trading services related to the investment recommendations, etc. Additionally, the computing device 2000 may be configured to receive user input from the user, such as user credential information, investment related search queries, website URLs, etc., and transmit the user input to the server 130 and/or the external sources of user content 140, etc. In this case, the analysis server 132 may use the user input to retrieve the user content from the external sources of user content 140. Further discussion regarding the analysis of the user content will be provided in connection with FIGS. 4 to 9.

Additionally, the computing device 2000 may also provide communication and/or messaging services for the one or more users of the online investment platform which allows users of the online investment platform to contact and/or message one or more other users of the online investment platform via the computing device 2000. For example, the computing device 2000 may also provide an online community (e.g., a forum, a website, a portal, a discussion board, an investment advisor service, a fraud investigation service, a group chat service, a teleconference service, a videoconference service, etc.) wherein users of the online investment platform may transmit messages for employees of the online investment platform, such as brokerage advisors, financial advisors, IT administrators, other users of the online investment platform, or a subset of the users of the online investment platform. Moreover, the online investment platform may provide one or more sections and/or areas dedicated to different categories of interest to the users (e.g., security topics, trading advice, financial news, political news, national/world news, etc.).

While FIG. 2 depicts an example embodiment of a client computing device 2000, the computing device 2000 is not limited thereto, and may include additional and/or alternative architectures that may be suitable for the purposes demonstrated. For example, the functionality of the computing device 2000 may be divided among a plurality of physical, logical, and/or virtual computing devices, network elements, etc.

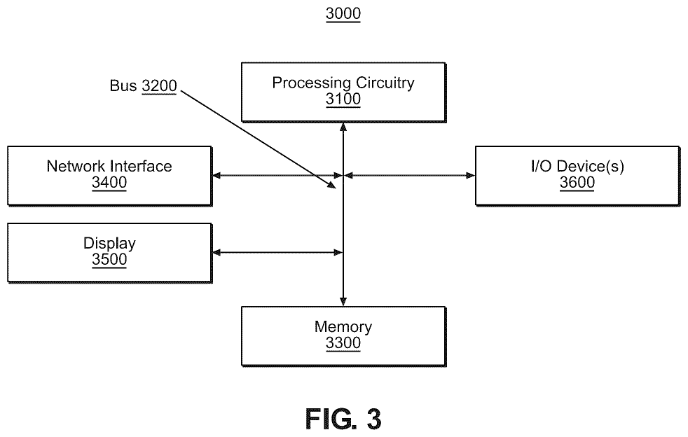

FIG. 3 illustrates a block diagram of an example server computing device of the online investment platform according to at least one example embodiment. The computing device 3000 of FIG. 3 may correspond to the server 130, the trading server 131, the analysis server 132, the social media account 141, and/or the other external sources of user content 142 of FIG. 1, but the example embodiments are not limited thereto.

Referring to FIG. 3, a computing device 3000 may include processing circuitry 3100, at least one communication bus 3200, a memory 3300, at least one network interface 3400, and/or at least one input/output (I/O) device 3600 (e.g., a keyboard, a touchscreen, a mouse, a microphone, a camera, a speaker, etc.), etc., but the example embodiments are not limited thereto. For example, the computing device 3000 may further include a display panel 3500, such as a monitor, a touchscreen, a projector, etc. The memory 3300 may include various special purpose program code including computer executable instructions which may cause the computing device 3000 to perform one or more of the methods of the example embodiments, including but not limited to computer executable instructions related to an online investment platform, a trained neural network (and/or a trained machine learning algorithm, a trained artificial intelligence model, a multi-modal large language model, a generative pre-trained transformer, etc.) for performing object detection on images and videos, performing speech detection on speech included in audio, and/or performing language detection on text, etc., and generating theme-based investment recommendations and/or research based on the output of the trained neural network, etc.

In at least one example embodiment, the processing circuitry 3100 may include at least one processor (and/or processor cores, distributed processors, networked processors, etc.), which may be configured to control one or more elements of the computing device 3000, and thereby cause the computing device 3000 to perform various special purpose operations. The processing circuitry 3100 is configured to execute processes by retrieving special purpose program code (e.g., computer readable instructions) and data from the memory 3300 to process them, thereby executing special purpose control and functions of the entire computing device 3000. Once the special purpose program instructions are loaded into the processing circuitry 3100, the processing circuitry 3100 executes the special purpose program instructions, thereby transforming the processing circuitry 3100 into special purpose processing circuitry (e.g., a special purpose processor, etc.).

In at least one example embodiment, the memory 3300 may be a non-transitory computer-readable storage medium and may include a random access memory (RAM), a read only memory (ROM), and/or a permanent mass storage device such as a disk drive, or a solid state drive. Stored in the memory 3300 is program code (i.e., computer readable instructions) related to operating the online investment platform (e.g., performing object detection on images and video, performing language detection on speech in video, and/or performing language detection on text, and/or generating theme-based investment recommendations and/or research based on the output of the trained neural network, etc.) and/or the computing device 3000, such as the methods discussed in connection with FIGS. 4 to 9, the at least one network interface 3400, and/or at least one I/O device 3600, etc. Such software elements may be loaded from a non-transitory computer-readable storage medium independent of the memory 3300, using a drive mechanism (not shown) connected to the computing device 3000, or via the at least one network interface 3400, and/or at least one I/O device 3600, etc.

In at least one example embodiment, the at least one communication bus 3200 may enable communication and/or data transmission to be performed between elements of the computing device 3000. The bus 3200 may be implemented using a high-speed serial bus, a parallel bus, and/or any other appropriate communication technology. According to some example embodiments, the computing device 3000 may include a plurality of communication buses (not shown).

The computing device 3000 may be associated with an online investment platform and may operate as, for example, a trading server, a brokerage server, a financial services server (e.g., banking services, loan services, etc.), an analysis server (e.g., image analysis server, audio analysis server, text analysis server, a web server, a messaging server, a search server, a news server, etc., or any combinations thereof, and may be configured to provide security trading services and/or financial services to at least one user of the online investment platform, generate investment recommendations for at least one user of the online investment platform, and/or provide investment research information for at least one user of the online investment platform. Additionally, the computing device 3000 may also provide communication and/or messaging services for the one or more users of the online investment platform which allows users of the online investment platform to contact and/or message one or more other users of the online investment platform via the computing device 3000. For example, the computing device 3000 may also provide an online community (e.g., a forum, a website, a portal, a discussion board, an investment advisor service, a group chat service, a teleconference service, a videoconference service, etc.) wherein users of the online investment platform may transmit messages for employees of the online investment platform, such as brokerage advisors, financial advisors, IT administrators, other users of the online investment platform, or a subset of the users of the online investment platform. Moreover, the online investment platform may provide one or more sections and/or areas dedicated to different categories of interest to the users (e.g., security topics, trading advice, financial news, political news, national/world news, etc.).

According to at least one example embodiment, the computing device 2000 may host an online investment platform providing users with the ability to perform securities transactions, e.g., purchases and/or sales of stocks, purchase and/or sales of options contracts, obtaining loans for purchasing stocks, etc., but are not limited thereto, and for example, the online investment platform is not limited to stocks, and may include other classes and/or categories of securities (such as bonds, commodities, real estate, etc.), other classes and/or categories of transactions, etc. The online investment platform may generate investment recommendations for at least one user of the online investment platform, and/or provide investment research information for at least one user of the online investment platform by, for example, obtaining one or more images associated with the at least one user, recognizing at least one object included in the one or more images using image analysis, determining at least one theme out of a plurality of theme associated with the recognized object, and providing recommendations to the at least one user related to the determined theme, but the example embodiments are not limited thereto. The methods for providing theme-based recommendations according to some example embodiments will be discussed in further detail in connection with FIGS. 4 to 9.

While FIG. 3 depicts an example embodiment of a computing device 3000, the computing device 3000 is not limited thereto, and may include additional and/or alternative architectures that may be suitable for the purposes demonstrated. For example, the functionality of the computing device 3000 may be divided among a plurality of physical, logical, and/or virtual servers and/or computing devices, network elements, etc.

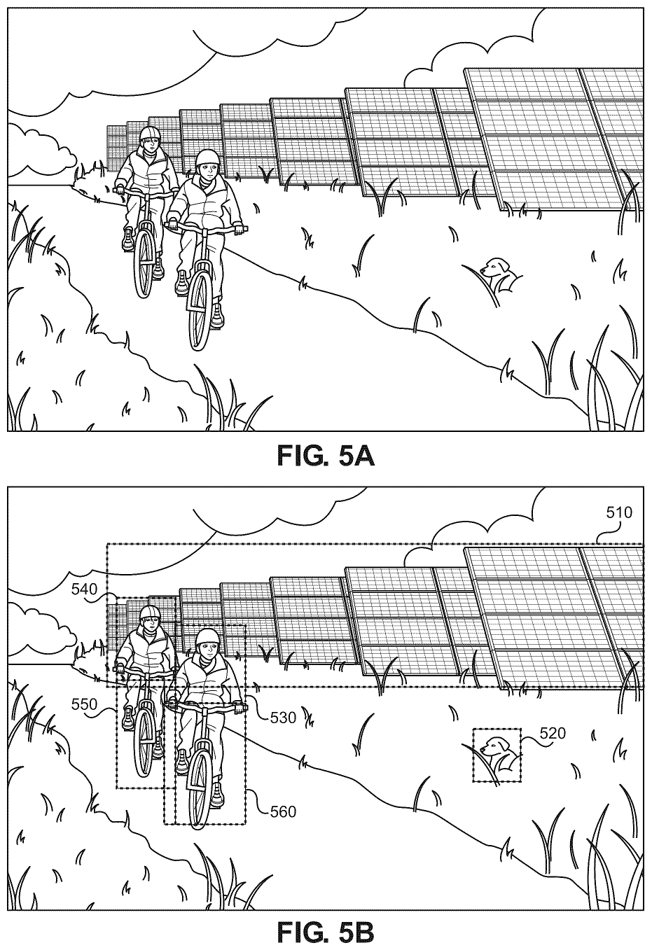

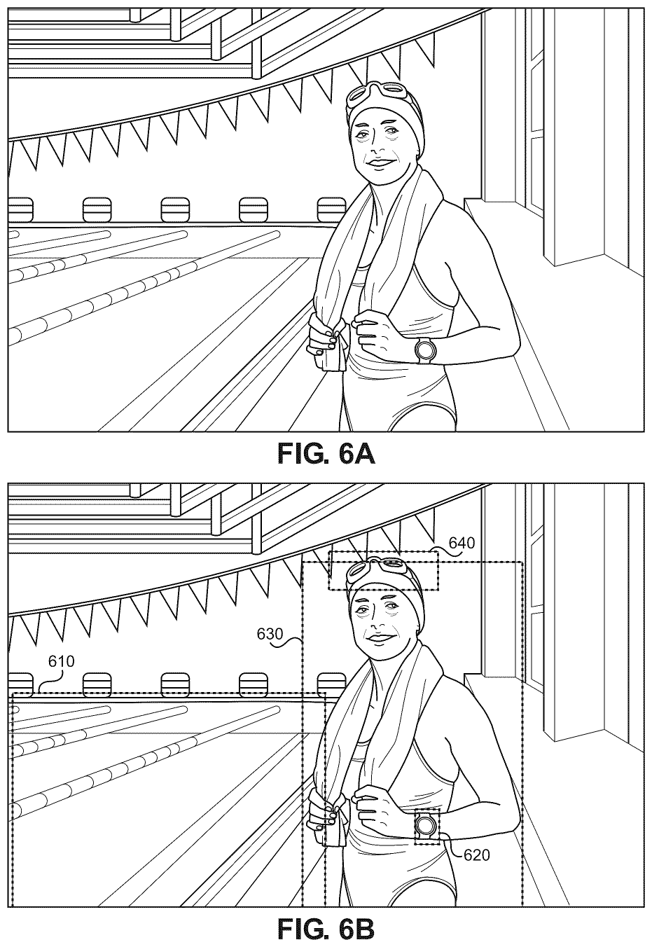

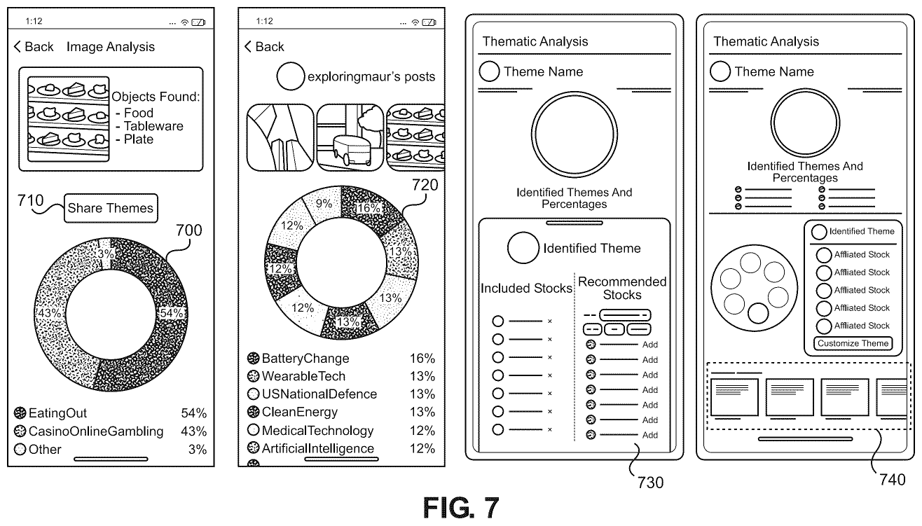

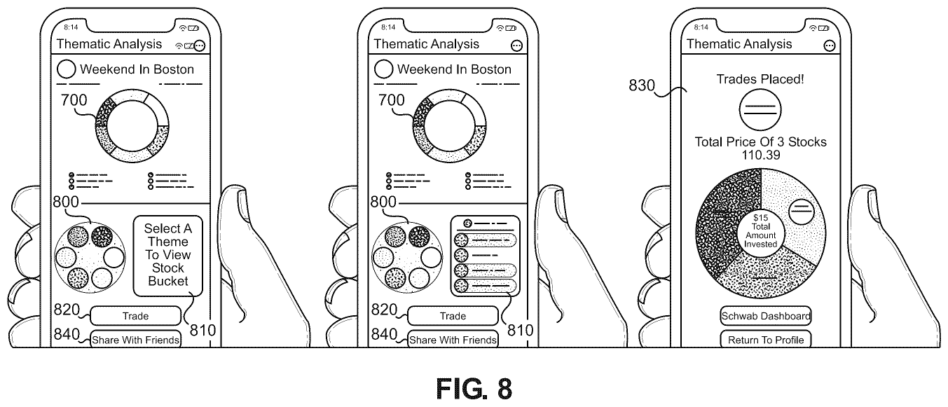

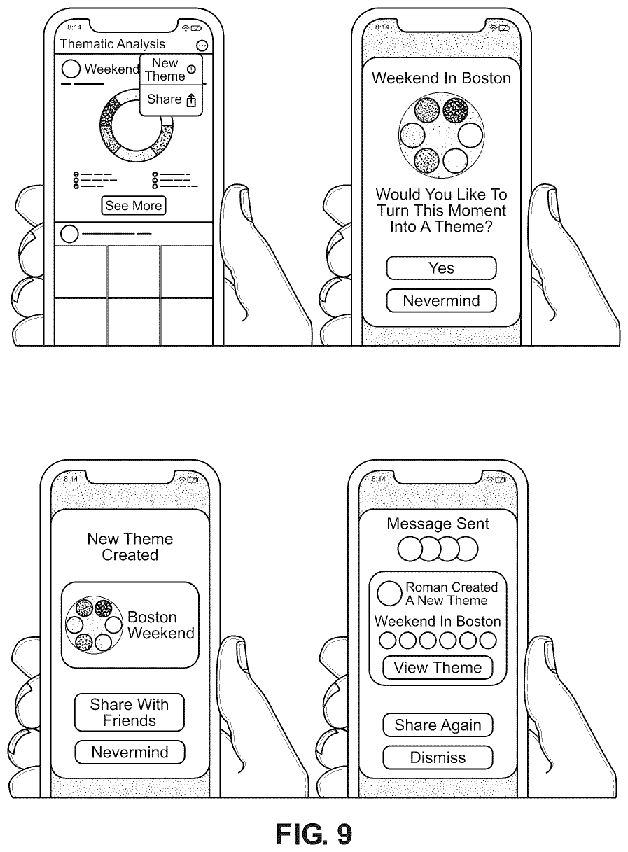

FIG. 4 illustrates a transmission flow diagram according to at least one example embodiment. FIGS. 5A to 5B illustrate image analysis performed on a first example image according to some example embodiments, and FIGS. 6A to 6B illustrate image analysis performed on a second example images according to some example embodiments. FIG. 7 illustrates example theme-based investment recommendation graphical user interfaces (GUIs) according to at least one example embodiment, FIG. 8 illustrates example theme-based investment research and trading GUIs according to at least one example embodiment, and FIG. 9 illustrates example theme creation and sharing GUIs according to at least one example embodiment. While FIGS. 4 to 9 illustrate the use of images and image analysis, the example embodiments are not limited thereto, and for example, audio and/or text may be used to generate theme-based recommendations.

Referring now to FIG. 4, according to at least one example embodiment, in operation S410, a user of the online trading platform may open and/or execute a software application (e.g., app, computer program, etc.) corresponding to and/or associated with the online trading platform on a client device, such as one or more of the client devices 100 of FIG. 1, but is not limited thereto. The user may input user credential information into the software application related to an account on at least one user content source 140, such as at least one social media service, an email service, a photo service, a cloud storage service, a messaging service, a search engine, a news server, a gaming service, a website, a forum, etc., but is not limited thereto. The user credential information may include an account identifier associated with the user's account on the user content source 140, a password associated with the user's account, biometric information of the user (and/or a token corresponding to the biometric information of the user, etc.), a PIN code, or the like. In operation S420, the software application may transmit a request for access to the user's account to the user content source 140, the request for access including the user credential information. The user content source 140 may verify the user credential information to determine whether to grant the software application access to user generated content, user data, and/or other information stored in association with the user's account, such as images, videos, audio, text, search engine queries, messaging chat logs, post history, articles viewed, games played, etc. In response to the user content source 140 successfully verifying the user credential information, the user content source 140 may grant access of the user account to the software application/client device 100, or in response to failure of the user credential information verification, the user content source 140 will deny access of the user account to the software application/client device 100. In at least one example embodiment, in the event of a successful user account verification, the user content source 140 may transmit a persistent and/or semi-persistent token to the client device 100 to enable the client device 100 to access the user's account on the user content source 140 for a desired time period. In other example embodiments, the client device 100 may perform the user credential validation for every access attempt of the user content source 140, the user content source 140 may perform user credential validation by recognizing the client device 100 based on device fingerprint information associated with the client device 100, e.g., a device identifier of the client device 100, an IP address and/or MAC address of the client device 100, etc., but the example embodiments are not limited thereto.

In operation S430, assuming that the client device 100 received a token from the user content source 140, the client device 100 may transmit the account identifier and the received token to the user content source 140 and access the user generated content stored in association with the user account on the user content source 140, such as photos captured by the user, videos captured by the user, audio captured by the user, text written by the user, etc. In operation S440, the client device 100 may display a list of the user generated content stored in association with the user content on a graphical user interface (GUI) of the software application. Further, the client device 100 may repeat operations S410 to S430 for additional user content sources associated with the user and/or the client device 100 may obtain user generated content associated with accounts of other users besides the user of the client device 100, e.g., the account of one or more second users of the online trading platform, friend accounts of the user of the client device 100, subscribed accounts of the user of the client device 100, public accounts viewed by the user of the client device 100, etc., and list the user generated content from the additional user content sources and/or the other user accounts in the GUI of the software application. According to some example embodiments, the user may also use the GUI to identify and/or search for user generated content from the user content source 140 and/or additional user content sources based on keywords (e.g., keywords associated with a desired event, etc.), AI prompts geolocation information, timestamp information, and/or any other type of metadata, and the search results may be displayed on the list of user generated content of the GUI.

Additionally, in some example embodiments, operations S410 to S430 may be omitted, and the user generated content may be content captured using and/or stored on the client device 100 itself, and may be included in the list of user generated content displayed on the GUI of the software application. Additionally, or alternatively, the user generated content may be content captured by multiple users of the online trading platform and/or multiple client devices 100 associated with the same user or different users, etc. The GUI of the software application and other operations related to the GUI of the software application will be discussed in greater detail in connection with FIGS. 7 to 9.

In operation S450, the user may select one or more of the user generated content, e.g., photos, videos, audio, text, etc., from the list displayed on the GUI of the software application and transmit the selected user generated content to the analysis server 130. Alternatively, in the event that the user generated content was not locally stored on the client device 100 and was instead stored on the user content source(s) 140, the software application may trigger the analysis server 130 to obtain a copy of the selected user generated content from the relevant user content source(s) 140. Once the analysis server 130 obtains a copy of the user generated content, the user generated content may be converted into a desired file format for analysis, while preserving the relevant metadata (e.g., location metadata, file creation metadata, user metadata, etc.) associated with the user generated content. For example, images of various file types, such as JPEG, RAW, BMP, TIFF, PDF, etc., may be converted into PNG files, but the example embodiments are not limited thereto. Further, for video files, the analysis server 130 may convert each individual frame of the video file into an image file of the desired file type, etc.

In operation S460, the analysis server 130 may identify objects contained in the converted image files using a neural network trained for object detection in images, machine learning algorithms trained for object detection, a multi-modal large language model trained for object detection, or the like. In the event that the user generated content is text-based, operation S460 may be omitted. In the event that the user generated content is audio-based, the analysis server 130 may identify words spoken and/or identifiable sounds contained in the converted audio files using a neural network and/or machine learning algorithms trained for speech identification (e.g., speech-to-text processes, etc.), but the example embodiments are not limited thereto. According to at least one example embodiment, the analysis server 130 may use, for object detection in images, You Only Look Once (YOLO), Faster R-CNN, Single Shot MultiBox Detector (SSD), Mask R-CNN, EfficientDet, etc., but the example embodiments are not limited thereto. According to at least one example embodiment, the analysis server 130 may use, for object (topic) detection in text, Latent Direchlet Allocation (LDA), Latent Semantic Analysis (LSA), word embedding-based methods, Bidirectional Encoder Representations from Transformers (BERT), graph-based methods, large language models (LLMs), etc., but is not limited thereto.

For example, as shown in FIG. 5A, the user generated content may be a photo taken by the user of two bicyclists riding on a dirt path next to a series of solar panels from a solar farm. The analysis server 130 may analyze the image to attempt to identify one or more objects in the image and determine object names for the identified objects. Further, the analysis server 130 may determine a level of confidence for each of the identified objects and the corresponding identified object name, and output the identified object and the corresponding object name as the results of the image analysis in response to the level of confidence for the identified object exceeding a desired threshold confidence level. According to some example embodiments, the analysis server 130 may be tuned such that it does not determine common, non-specific, and/or generic words as object names for identified objects, such as “human,” “man,” “woman,” “animal,” “vehicle,” etc. As shown in FIG. 5B, the analysis server 130 may output the object names “solar farm” for the first identified object 510, “dog” for the second identified object 520, “biker” for the third and fourth objects 530 and 540, and “bicycle” for the fifth and sixth objects 550 and 560, but the example embodiments are not limited thereto.

As another example, in FIG. 6A, the user generated content may be a photo of a swimmer standing next to a swimming pool. The analysis server 130 may output “swimming pool” as the object name of the first identified object 610, “smart watch” as the object name of the second identified object 620, “swimmer” as the object name of the third identified object 630, “goggles” as the object name of the fourth identified object 640, etc.

Returning to FIG. 4, in operation S470, the identified object names may be provided as inputs to a trained natural language processing (NLP) model and compared to a list of investment related themes to determine the most relevant themes for the identified objects. According to at least one example embodiment, a theme may be a category (e.g., a basket, a group, etc.) of financial instruments having a desired commonality and/or characteristic. One or more financial instruments included in a theme may be related to an idea associated with the theme and/or a trend corresponding to the theme and may include financial instruments from the same or different financial sector, etc. For example, a “Renewable Energy” theme may include financial instruments associated with companies and/or services related to “expanding energy capacity by developing and implementing solar, wind, biofuel, and other non-fossil fuel technologies,” but the example embodiments are not limited thereto. One or more themes may be created and/or generated by financial analysts, users, etc., or may be automatically generated based on social media trends, current news events, popular search engine keywords, large language model (and/or artificial intelligence, neural network, machine learning, generative pre-trained transformer, etc.) prompts, etc. The financial instruments included in each theme may also be set by financial analysts, users, and/or may be automatically categorized by the analysis server 130, etc.

More specifically, the analysis server 130 may use the trained NLP model to determine a word distance between the identified object names and various keywords (e.g., criteria, indicia, tokens, etc.) associated with a plurality of themes stored on the analysis server 130. An example list of themes and associated keywords is provided in Table 1 below, but the example embodiments are not limited thereto.

TABLE 1

| Theme Name | Theme Associated Keywords |
|---|---|
| ActiveLifestyle | ‘fitness’, ‘equipment’, ‘golf’, ‘winter’, |
| | ‘sports’, ‘clubs’, ‘facilities’, ‘sporting’, |
| | ‘goods’, ‘athletic’, ‘apparel’, ‘sportswear’, |
| | ‘gear’, ‘boats’, ‘camping’, ‘health’, ‘exercise’, |
| | ‘biking’, . . . |
| ArtificialIntelligence | ‘artificial’, ‘intelligence’, ‘natural’, |
| | ‘language’, ‘processing’, ‘information’, |
| | ‘extraction’, ‘speech’, ‘recognition’, |
| | ‘computer’, ‘vision’, ‘machine’, ‘learning’, |
| | ‘neural’, ‘networks’, ‘parallel’, ‘facial’, |
| | ‘ranking’, . . . |
| CleanEnergy | ‘photovoltaic’, ‘modules’, ‘pv’, ‘cells’, |
| | ‘solar’, ‘power’, ‘products’, ‘installs’, ‘panel’, |
| | ‘wind’, ‘turbines’, ‘blades’, ‘biofuel’, . . . |
| PetPassion | ‘pet’, ‘veterinary’, ‘animals’, ‘dog’, ‘puppy’, |
| | ‘cat’, ‘kitten’, ‘turtle’, ‘rabbit’, ‘hamster’, |
| | ‘mouse’, ‘parrot’, ‘goldfish’, ‘tropical’, ‘fish’, |
| | ‘cage’, ‘snake’, ‘collar’, ‘ball’, ‘yarn’, . . . |
| USNationalDefense | ‘combat’, ‘vehicle’, ‘launch’, ‘maritime’, |
| | ‘systems’, ‘munitions’, ‘submarine’, |
| | ‘tactical’, ‘aerial’, ‘defense’, ‘missiles’, |
| | ‘mission’, ‘army’, ‘navy’, ‘air’, ‘force’, |
| | ‘ships’, ‘homeland’, ‘security’, . . . |
| WearableTech | ‘continuous’, ‘glucose’, ‘monitoring’, |
| | ‘system’, ‘cardiac’, ‘monitor’, ‘hearing’, |
| | ‘aid’, ‘fitness’, ‘tracker’, ‘smart’, ‘glasses’, |
| | ‘watch’, ‘wearable’, ‘technology’, |
| | ‘products’, ‘device’, ‘headset’, ‘virtual’, |
| | ‘reality’, ‘augmented’, . . . |
| CasinoOnlineGambling | ‘casino’, ‘las’, ‘vegas’, ‘macau’, ‘gaming’, |
| | ‘horse’, ‘racing’, ‘hotel’, ‘lotter’, ‘sports’, |
| | ‘betting’, ‘poker’, ‘cards’, ‘blackjack’, . . . |
| EatingOut | ‘quick’, ‘service’, ‘fast’, ‘food’, ‘franchise’, |
| | ‘barista’, ‘limited’, ‘casual’, ‘dining’, |
| | ‘coffee’, ‘shop’, ‘restaurants’, ‘dinner’, |
| | ‘lunch’, ‘breakfast’, . . . |
| MedicalTechnology | ‘defibrillator’, ‘heart’, ‘valves’, ‘orthopedic’, |
| | ‘reconstruction’, ‘knee’, ‘replacement’, |
| | ‘joint’, ‘implant’, ‘hip’, ‘cardiac’, ‘loop’, |
| | ‘recorder’, ‘surgical’, ‘robot’, ‘robotic’, |
| | ‘surgery’, ‘continuous’, ‘glucose’, . . . |
| BatteryChange | ‘battery’, ‘technology’, ‘packs’, ‘charger’, |
| | ‘ev’, ‘charging’, ‘hydrogen’, ‘fuel’, ‘cell’, |
| | ‘electric’, ‘vehicle’, ‘lithium’, ‘ion’, . . . |

The list of investment related themes and theme associated keywords may be determined by financial analysts associated with the online trading platform, may be based on experiential data (e.g., a list of the most common search keywords associated with the themes, most popular tokens, etc.), etc., but is not limited thereto. Further, the list of themes and/or theme associated keywords may be updated by the financial analysts and/or the user, etc.

The analysis server 130 determines and/or calculates word similarity scores between each of the identified object (e.g., object names) and the each of the theme associated keywords for the plurality of themes, using for example, a trained word2vec NLP model, a trained GloVe NLP model, or the like.

Next, the analysis server 130 determines and/or calculates a relevancy score representing the object-to-theme relevance for each theme in the plurality of themes based on the word similarity scores for each of the keywords associated with the respective theme. The relevancy score may be calculated by taking the mean cosine similarity score of every theme associated keyword associated with the theme, but the example embodiments are not limited thereto.

As an example, the analysis server 130 may calculate word similarity scores for the “solar farm” identified object 510 as shown below, but the example embodiments are not limited thereto:

TABLE 2

| Solar Farm | |
|---|---|
| “CleanEnergy” | 0.9342454314231873 |
| “BatteryChange” | 0.7375571810282193 |
| “USNationalDefense” | 0.5574310074040764 |
| “WearableTech” | 0.488479240735372 |
| “EatingOut” | 0.4614900410175323 |
| “ArtificialIntelligence” | 0.4501447253757052 |
| “PetPassion” | 0.4464005395770073 |
| “MedicalTechnology” | 0.4349134269513582 |
| “ActiveLifestyle” | 0.4150608006450865 |
| “CasinoOnlineGambling” | 0.4038581908387797 |

As a second example, the analysis server 130 may calculate word similarity scores for the “swimmer” identified object 630 as shown below, but the example embodiments are not limited thereto:

TABLE 3

| Swimmer | |
|---|---|
| “ActiveLifestyle” | 0.9150608006450865 |
| “WearableTech” | 0.488479240735372 |
| “EatingOut” | 0.5614900410175323 |
| “ArtificialIntelligence” | 0.4501447253757052 |
| “PetPassion” | 0.4464005395770073 |
| “MedicalTechnology” | 0.5349134269513582 |
| “CleanEnergy” | 0.5342454314231873 |
| “USNationalDefense” | 0.4174310074040764 |
| “BatteryChange” | 0.3375571810282193 |
| “CasinoOnlineGambling” | 0.3438581908387797 |

According to some example embodiments, the analysis server 130 may apply a desired relevancy score threshold value, e.g., 0.7 or higher, so that themes that are less relevant to the identified object name are filtered out, but the example embodiments are not limited thereto, and for example, the desired relevancy score threshold value may be greater or less than 0.7, etc.

Further, the analysis server 130 may generate mapping information wherein each theme from the filtered list of themes is associated with the maximum (e.g., highest, etc.) relevancy score received for the respective theme identified in the one or more pieces of user generated content (e.g., Image 1 from FIG. 5A and Image 2 from FIG. 6A, etc.), information such as the identified objects associated with the theme, the images containing the identified objects, the number of unique objects mapping to the theme, and/or the number of images which map to the theme, etc., but the example embodiments are not limited thereto.

TABLE 4

| | |
|---|---|
| ″CleanEnergy″ | max-relevancy:0.9342454314231873; |
| | objects:{“Solar Farm”}; |
| | images:{“Image 1”}; |
| | o:1; |
| | i:1 |
| ″BatteryChange″ | max-relevancy:0.7375571810282193; |
| | objects:{“Solar Farm”}; |
| | images: {Image 1”}; |
| | o:1; |
| | i:1 |
| ″ActiveLifestyle″ | max-relevancy:0.9640722105900446; |
| | objects:{“Biker”,”Dog”,”Swimmer”,”Pool”,”Smart |
| | Watch”}; |
| | images:{“Image 1”, “Image 2”}; |
| | o:5; |
| | i:2 |
| ″PetPassion″ | max-relevancy:0.938673748075962; |
| | objects:{”Dog”}; |
| | images:{“Image 1”}; |
| | o:1; |
| | i:1 |
| “WearableTech″ | max-relevancy:0.9873292744159699; |
| | objects:{“ Smart Watch”}; |
| | images:{ “Image 2”}; |
| | o:1; |
| | i:1 |
| ″ArtificialIntelligence″ | max-relevancy:0.7639748666021559; |
| | objects:{“ Smart Watch”}; |
| | images:{ “Image 2”}; |
| | o:1; |
| | i:1 |

According to some example embodiments, the analysis server 130 may cache the mapping information in memory for a desired period of time in order to reduce the number of natural language processing calls to determine word similarity scores and/or relevancy scores when the same objects are identified in additional pieces of user generated content (e.g., a future image includes a solar farm, a swimmer, a bicycle, etc.), thereby reducing the computer resource usage, increasing the speed of analysis, etc.

The analysis server 130 may further process the mapping information in order to improve the relevancy of the themes to the user's selected user generated content, by accounting for the number of occurrences of the most relevant themes in the set of selected user generated content based on 1) the number of object names mapping to the same theme, and 2) the number of individual pieces of user generated content mapping to the same theme. For example, the analysis server 130 may use the following equation to determine weighted scores associated with each of the most relevant themes:

$$Weighted score = ( ( o * w 1 + i * w 2 ) / t ) + max - relevancy \qquad [ Equation 1 ]$$

wherein o=# of unique objects mapping to the theme; i=# of images which map to a theme; t=total # of images selected by the user; w1=weighted multiplier for o; and w1=weighted multiplier for o.

According to some example embodiments, the weighted multipliers w1 and w2 may be set to account for different factors, e.g., temporal factors and/or spatial factors, etc., which may indicate a greater user interest to a theme. For example, a first user takes 3 pictures of coffee while on vacation in the same week may have less interest in a food-related theme than a second user who takes weekly coffee photos at various locations throughout the year. Therefore, according to at least one example embodiment, with respect to pieces of user generated content which map to the same theme, a comparison of the location data of each of the pieces of user generated content in the set of selected user generated content may be performed wherein a greater weight is applied to images that are taken at different locations than images that are taken from the same or within a desired distance from each other and/or a comparison of the time difference between the time when the pieces of user generated content were captured may be performed such that a greater weight is applied to images that are captured after greater lengths of time, etc., but the example embodiments are not limited thereto.

Assuming that w1=1, and w2=1, the analysis server 130 may generate the following weighted scores using Equation 1 and the data from Table 4 above, but the example embodiments are not limited thereto.

TABLE 5

| | |
|---|---|
| “ActiveLifestyle” | 4.464 |
| “WearableTech” | 1.987 |
| “PetPassion” | 1.938 |
| “CleanEnergy’ | 1.934 |
| “ArtificialIntelligence” | 1.763 |
| “BatteryChange” | 1.737 |

In operation S480, the analysis server 130 may transmit the list of themes and their respective weighted scores to the client device 100 for theme visualization (e.g., theme rendering, personalized theme recommendations, etc.) to the user on the GUI of the software application.

Referring now to FIG. 7, for example, the weighted scores for the list of most relevant themes to the selected user content data may be displayed as relative percentages of each theme on, for example, a pie chart, etc., on the theme visualization 700, thereby providing the user with a holistic portfolio view of all suggested themes on the theme visualization of the GUI. The weighted scores for each theme may correspond to the strength of recommendation (e.g., degree of relevance, etc.) of the particular suggested theme to the selected user content data. Further, the user may adjust the weight, e.g., the relative percentage, of one or more recommended themes of the plurality of suggested themes by providing user inputs to the theme visualization 700. The user inputs may adjust the weighted score (e.g., the relative percentage) of a selected theme from the plurality of suggested themes to the selected user content data, which may be used to adjust the percentage of financial instruments associated with each recommended theme purchased by the user (discussed in greater detail in connection with operation S490) and/or may be used as feedback data to further train the analysis server 130 and improve the relevancy of the themes to the user's selected user generated content. Each of the themes included in the displayed list of themes are associated with one or more recommended investment opportunities (e.g., baskets of recommended stocks, bonds, real estate, etc.) relevant to the theme. Further, the user may also display a theme visualization 720 corresponding to an average and/or combination of recommended themes from a plurality of content sources as shown in FIG. 7. For example, the averaged theme visualization 720 may include the recommended themes from two or more social media accounts/services associated with the user, may include a combination of user generated content stored locally on the client device 100 and one or more social media accounts associated with the user, etc. Moreover, the client device 100 may periodically update theme visualization 700 and/or 720 based on new user generated content stored on the client device 100 and/or uploaded to the one or more social media accounts, etc., of the user at desired time intervals.

According to some example embodiments, the user may view the recommended investment opportunities by clicking on and/or drilling down on each segment of the pie chart to view the associated themed basket of recommended investment opportunities 730. Further, each of the one or more themes may also be associated with research information 740 related to the potential investment opportunities, such as regulatory filings, financial data, financial news articles associated with the potential investment opportunity, etc., thereby simplifying and/or speeding up the research process for the user.

Referring again to FIG. 4, in operation S490, the user of the client device 100 may share (e.g., transmit, etc.) themes and/or baskets of recommended investment opportunities with other users by clicking on the share theme GUI button 710 of FIG. 7 and/or the share theme GUI button 840 of FIG. 8, etc. Additionally, the user may receive and view themes and/or baskets of recommended investment opportunities from other users via the GUI of the software application.

Moreover, the user may directly conduct trade transactions for one or more of the recommended investment opportunities through the GUI of the software application as shown in FIG. 8, but is not limited thereto, and for example, a modified and/or different GUI may be displayed in the event that a VR device and/or AR device is used for the client device 100 by the user. Referring now to FIG. 8, when the user drills into one or more themes displayed on the theme visualization 700, a theme-based trading GUI 800 may be displayed on the GUI of the software application. When the user selects one or more themes from the trading GUI 800, the recommended investment opportunities associated with the selected theme(s) are displayed in the GUI element 810. Additionally, the user may also trade the selected recommended investment opportunities by clicking on the trade GUI button 820, which causes the trading GUI 830 to be shown. The user may enter a transaction price (e.g., a purchase price, a sell price, a limit price, a market price, etc.), the number of securities to be transacted, time limits on the transaction, etc., and execute the transaction via the trading GUI 830. Moreover, the user may trade the entire bucket of recommended investment opportunities associated with one or more selected themes via the trading GUI 830 as well.

Further, the user may create a custom theme associated with an experience of the user as shown in FIG. 9. For example, the user may wish to create an experience (e.g., the custom theme) based on a particular set of user generated content of particular interest to the user, such as a weekend vacation to Boston. The user may store and/or select the user generated content associated with the desired experience, perform operations S450 to S480 for the user generated content associated with the desired experience, and then save the resulting list of recommended themes and/or theme visualization as the experience. Alternatively, or additionally, the user may create the experience by selecting two or more themes from the plurality of themes provided by the online trading platform and combining the selected two or more themes into a single experience, e.g., a single custom theme, as well as adjust the weighting of individual themes and/or recommended financial instruments included in one or more of the selected themes as desired. The user may further share the experience (e.g., custom theme) with friends, conduct research on the recommended investment opportunities corresponding to the list of recommended themes, and/or conduct trades regarding the recommended investment opportunities as discussed above.

While FIGS. 4 to 9 illustrate various methods for providing theme based investment recommendations, the example embodiments are not limited thereto, and other methods may be used and/or modifications to the methods may be used to provide theme based investment recommendations of the example embodiments.

This written description uses examples of the subject matter disclosed to enable any person skilled in the art to practice the same, including making and using any devices, systems, and/or non-transitory computer readable media, and/or performing any incorporated methods. The patentable scope of the subject matter is defined by the claims, and may include other examples that occur to those skilled in the art. Such other examples are intended to be within the scope of the claims.

What is claimed is:

1. A computing device comprising:
a memory storing computer readable instructions; and
processing circuitry configured to execute the computer readable instructions to cause the computing device to,
obtain at least one image associated with at least one user,
recognize at least one object included in the at least one image using image analysis,
determine at least one theme from a plurality of themes based on the recognized at least one object, and
provide at least one recommendation to the at least one user based on the at least one theme.

2. The computing device of claim 1, wherein the processing circuitry is further configured to execute the computer readable instructions to cause the computing device to:
obtain a plurality of images from a source of images associated with the at least one user, the plurality of images including the at least one image; and
receive at least one user input from the user, the at least one user input selecting the at least one image from the plurality of images.

3. The computing device of claim 1, wherein the processing circuitry is further configured to execute the computer readable instructions to cause the computing device to recognize the at least one object included in the at least one image by, for each image of the at least one image:
identifying each object included in the respective image, the identifying including calculating a confidence value associated with each identified object; and
for each identified object,
determining an object name corresponding to the respective identified object in response to the confidence value associated with the respective identified object satisfying a desired threshold confidence value, and
associating the respective identified object with the respective image as the recognized at least one object associated with the respective image.

4. The computing device of claim 3, wherein
the plurality of themes are each associated with a set of keywords; and
the processing circuitry is further configured to execute the computer readable instructions to cause the computing device to determine the at least one theme based on the recognized at least one object by:
determining a relevance score using a natural language processing model between each recognized object associated with the at least one image and each theme of the plurality of themes based on the determined object name of the respective recognized object and the keywords associated with the respective theme; and
determining the at least one theme associated with the at least one image based on the determined relevance scores.

5. The computing device of claim 4, wherein the processing circuitry is further configured to execute the computer readable instructions to cause the computing device to determine the at least one theme associated with the at least one image based on the determined relevance scores by:
determining a word similarity score between the determined object name of each recognized object and each of the keywords associated with the respective theme;
determining a relevancy score based on the determined word similarity scores between the determined object name and the respective theme; and
associating the respective theme to the respective image corresponding to the respective object based on the determined relevancy score and a desired theme threshold value.

6. The computing device of claim 5, wherein
the at least one theme associated with the at least one image is a plurality of themes associated with the at least one image; and
the processing circuitry is further configured to execute the computer readable instructions to cause the computing device to determine at least one recommendation associated with each of the plurality of themes associated with the at least one image.

7. The computing device of claim 6, wherein
the at least one image associated with the user is a plurality of images associated with the user, each of the plurality of images associated with a plurality of themes; and
the processing circuitry is further configured to execute the computer readable instructions to cause the computing device to:
calculate a weighted score for each of the plurality of themes, and
provide the at least one recommendation to the at least one user based on the weighted score of each of the plurality of themes.

8. The computing device of claim 7, wherein the processing circuitry is further configured to execute the computer readable instructions to cause the computing device to calculate the weighted score for each of the plurality of themes by:
applying a weight to a maximum relevance score for each of the plurality of themes based on at least one of:
a number of occurrences of the respective theme among the plurality of images, a number of recognized objects mapping to the respective theme among the plurality of images, a number of distinct images mapping to the respective theme, timestamp information associated with the distinct images mapping to the respective theme, geolocation information associated with the distinct images mapping to the respective theme, or any combinations thereof.

9. The computing device of claim 7, wherein the processing circuitry is further configured to execute the computer readable instructions to cause the computing device to:
display the at least one recommendation associated with each of the plurality of themes based on a ranking of the weighted relevance score of each of the plurality of themes.

10. The computing device of claim 1, wherein the processing circuitry is further configured to execute the computer readable instructions to cause the computing device to:
obtain at least one second image associated with at least one second user,
recognize at least one second object included in the at least second one image using image analysis,
determine the at least one theme from the plurality of themes based on the recognized at least one object and the recognized at least one second object, and
provide the at least one recommendation to the at least one user and the at least one second user based on the at least one theme.

11. The computing device of claim 1, wherein the processing circuitry is further configured to execute the computer readable instructions to cause the computing device to:
receive a user input indicating creation of a new theme from the user;
provide a plurality of themes to the user;
receive a selection of at least two themes of the plurality of themes in response to the providing of the plurality of themes; and
generate a new theme based on the selection of the at least two themes.

12. A method of operating a computing device comprising:
obtaining at least one image associated with at least one user;
recognizing at least one object included in the at least one image using image analysis;
determining at least one theme from a plurality of themes based on the recognized at least one object; and
providing at least one recommendation to the at least one user based on the at least one theme.

13. The method of claim 12, further comprising:
receiving account credential information from the at least one user;
obtaining a plurality of images associated with at least one account of the at least one user from a server based on the account credential information, the plurality of images including the at least one image; and
receiving at least one user input from the user, the at least one user input selecting the at least one image from the plurality of images.

14. The method of claim 12, wherein the recognizing the at least one object included in the at least one image further includes, for each image of the at least one image:
identifying each object included in the respective image, the identifying including calculating a confidence value associated with each identified object; and
for each identified object,
determining an object name corresponding to the respective identified object in response to the confidence value associated with the respective identified object satisfying a desired threshold confidence value, and
associating the respective identified object with the respective image as the recognized at least one object associated with the respective image.

15. The method of claim 14, wherein
the plurality of themes are each associated with a set of keywords; and
the determining the at least one theme based on the recognized at least one object further includes:
determining a relevance score using a natural language processing model between each recognized object associated with the at least one image and each theme of the plurality of themes based on the determined object name of the respective recognized object and the keywords associated with the respective theme; and
determining the at least one theme associated with the at least one image based on the determined relevance scores.

16. The method of claim 15, wherein the determining the relevance score using the natural language processing model further includes:
determining a word similarity score between the determined object name of each recognized object recognized object and each of the keywords associated with the respective theme;
determining a relevance score of the determined word similarity scores between the determined object name and the respective theme; and
associating the respective theme to the respective image corresponding to the respective object based on the determined relevance score and a desired theme threshold value.

17. The method of claim 16, wherein
the at least one theme associated with the at least one image is a plurality of themes associated with the at least one image; and
the method further comprises,
determining at least one recommendation associated with each of the plurality of themes associated with the at least one image.

18. The method of claim 17, wherein
the at least one image associated with the user is a plurality of images associated with the user, each of the plurality of images associated with a plurality of themes; and
the method further comprises:
calculating a weighted relevance score for each of the plurality of themes, and
providing the at least one recommendation to the at least one user based on the weighted relevance score of each of the plurality of themes.

19. The method of claim 18, wherein the calculating the weighted relevance score for each of the plurality of themes further includes:
applying a weight to a maximum relevance score for each of the plurality of themes based on at least one of:
a number of occurrences of the respective theme among the plurality of images, a number of recognized objects mapping to the respective theme among the plurality of images, a number of distinct images mapping to the respective theme, timestamp information associated with the distinct images mapping to the respective theme, geolocation information associated with the distinct images mapping to the respective theme, or any combinations thereof.

20. The method of claim 18, further comprising:
displaying the at least one recommendation associated with each of the plurality of themes based on a ranking of the weighted relevance score of each of the plurality of themes.

21. The method of claim 12, further comprising:
obtaining at least one second image associated with at least one second user,
recognizing at least one second object included in the at least second one image using image analysis,
determining the at least one theme from the plurality of themes based on the recognized at least one object and the recognized at least one second object, and
providing the at least one recommendation to the at least one user and the at least one second user based on the at least one theme.

22. The method of claim 12, further comprising:
receiving a user input indicating creation of a new theme from the user;
providing a plurality of themes to the user;
receiving a selection of at least two themes of the plurality of themes in response to the providing of the plurality of themes; and
generating a new theme based on the selection of the at least two themes.
